(19) United States
(12) Patent Application Publication
(10) Pub. No.: US 2013/0211854 A1
(43) Pub. Date: Aug. 15, 2013

(54) Decoding, Model and Presentation System

(71) Applicant: David Lloyd Wagstaff, Lake Forest, CA (US)

(72) Inventor: David Lloyd Wagstaff, Lake Forest, CA (US)

(73) Assignee: LANTRONIX, INC., Irvine, CA (US)

(21) Appl. No.: 13/880,882

(22) PCT Filed: Oct. 20, 2011
(86) PCT No.: PCT/US11/57169

§ 371 Date: Apr. 22, 2013

Related U.S. Application Data
(60) Provisional application No. 61/406,927, filed on Oct. 26, 2010.

(51) Int. Cl. G06F 19/00

(52) U.S. Cl. CPC G06F 19/3418
USPC 705/2

(57) ABSTRACT

System and methods to allow for communication, decoding, interpretation and presentation of information received from a plurality of medical devices in a health care network is provided. Information that is received from the medical device may be decoded by the system into metrics based on values extracted from the medical device. The system may then model the decoded information and/or metrics into a format which is useful for an end user. Additionally, the system may then have a presentation model which allows the information to be presented to the end user via a preferred display mechanism. In an embodiment, the mechanism may be a chart, graph or text readout. The system may have a sensor incorporated which produces the metric and decodes the raw data received from the medical devices. The system may also include a controller which may view all data received from the medical devices and analyzes for changes.

### PRIORITY CLAIM

This application claims priority to PCT International Patent Application No. PCT/US2011/057169 filed on Oct. 20, 2011 and U.S. Provisional Application No. 61/406,927 filed on Oct. 26, 2010, entitled “Decoding, Model and Presentation System” which is incorporated by reference.

### FIELD OF THE INVENTION

The present invention relates to medical device connectivity and more particularly, to a set of decoding mechanisms to allow for model and presentation to an end user of information received from an electronic device such as a medical device.

### BACKGROUND

The number of network-connected devices has grown dramatically over the last decade. Such growth is expected to continue far into the future, causing enormous problems of integration for consumers, companies, and governments. One significant problem is the inclusion of many legacy devices that were never intended to be connected to a network. For instance, gaining information regarding bulb life on a projector can reduce down time by allowing a manager to replace the bulb before it burns out. But light bulbs and electrical systems that operate light bulbs are generally not designed to be networked.

Another problem is the ever-growing number of network enabled devices that have inadequate monitoring and control capabilities. These problems are pervasive, involving all manners of equipment from fax machines, printers, copiers and other office equipment, to specialized devices found in manufacturing plants, home appliances, hand-held electronics such as cameras, audio/video players and medical devices that have network capability but are not part of an integrated network. This problem is particularly acute for the administrators, who often find themselves spending a great deal of money and time bridging heterogeneous management systems. Most of these devices do not contain state information and are even more difficult to manage. A more homogeneous management environment can save time and money, but numerous vendors have many valid business and technical reasons for avoiding homogeneous management systems.

Device management functionality comes in many different forms depending on the administrator's needs and the capabilities of the target device. Common management functions include monitoring the device's critical information, taking an inventory of the device sub-systems, logging interesting events that take place, sending alerts to an administrator, recovering the device if the power fails, ensuring that the data is secure, asset tracking, or reporting information to an administrator. Administrators also employ more advanced management functions including scripting or programming, aggregating device data from multiple devices, diagnostics, taking action based on the device data content, trending device data, reporting information in a final format including a spreadsheet or graph, or translating from one management format to another. A major area of management functionality includes securing the device by providing confidentiality of data, data integrity, administrator authentication, device authentication, risk mitigation, countermeasures, or protection against hostile environments and threats.

For example, various medical devices surrounding a patient's bed operate independently of each other and include non-standard wires, tubes, and interfaces. One problem is lack of integration between the medical devices. Some medical devices generate information in a proprietary format, which is not compatible with other medical devices from different vendors. In another example, a medical device may produce an analog signal for a patient's vital signs, but because the signal is not digital or recorded, the analog signal must be transcribed onto a piece of paper or else the information is lost. As a result of this lack of integration, health care professionals must pay greater attention to control and monitor many medical devices individually, requiring more personnel to transcribe the data, more time to review the data, and greater potential for lost data and transcription error. Some devices with analog signals may store the data for short periods of time but again, the time must be taken later to review and transcribe the information. Additionally, there is little to no integration between the plurality of medical devices. Additionally, the presentation of the information from the medical device is not made to the end user in a meaningful way to be able to interpret and understand the information received from the medical device.

Therefore, a need exists for a system and method that may communicate with each of a plurality of medical devices within a health care network. Moreover, a need exists for a system and method that may communicate data from a plurality of different medical devices and further may decode information from the medical device and present the information decoded from the medical device to an end user in a meaningful way whereby the end user understands the data presented.

### SUMMARY OF THE INVENTION

The present invention employs a system and method to allow for communication, decoding, interpretation and presentation of information received from a plurality of medical devices in a health care network. Information that is received from the medical device may be decoded by the system into metrics based on values extracted from the medical device. The system may then model the decoded information and/or metrics into a format which is most useful for an end user. Additionally, the system may then have a presentation model which allows the information to be presented to the end user via a preferred display mechanism. In an embodiment, the mechanism may be a chart, graph or text readout. Moreover, the system may further have a sensor incorporated therein which produces the metric and decodes the raw data received from the medical devices. Further, the system may also include at least a controller which may view all data received from medical devices and analyze it for changes in medical software to determine if errors or upgrades to the medical devices have been implemented. In addition, the model is bidirectional in that it may be used to represent data and can be modified by applications and the changes may be reflected by the medical device.

To this end, in an exemplary embodiment of the present invention, a system for decoding and presenting information from a medical device connected to a medical facility network, the system comprising: a terminal interfacing with the medical facility network; a plurality of medical devices within range of the medical facility network; and wherein information received from the plurality of medical devices is transmitted to a system processor which reads the information received and decodes the information into utilizable metrics which are then transmitted to a modeling module for further processing.

In an exemplary embodiment, wherein a plurality of medical devices may be identified and information from a plurality of medical devices may be decoded.

In an exemplary embodiment, wherein the system provides a modeling module whereby the modeling module which presents information from the plurality of medical devices to an end user in a pre-determined fashion.

In an exemplary embodiment, wherein the system provides a modeling module which transforms decoded information from a medical device into any of a chart, group, or structure that is readily useable by an end user.

In an exemplary embodiment, wherein the system further comprises a presentation module which presents the information to the end user in a way that the data is fully understood by the end user.

In an exemplary embodiment, wherein the system further comprises a controller which looks for changes in information received from the plurality of medical devices.

In an exemplary embodiment, wherein the system further comprises a controller which reviews for changes in software, hardware and automatically upgrades the system when a change has been detected.

In an exemplary embodiment, wherein the controller tracks data related to the most current software versions and hardware versions and determines when a medical device connected to the system requires an upgrade.

In an exemplary embodiment, a sensor that produces a metric that decodes information from the medical devices and sends it to the modeling portion of the system for further evaluation and manipulation.

In an exemplary embodiment, further comprising a Medical Device Gateway (MDG).

In an exemplary embodiment of the present invention, a method for decoding and presenting information from a medical device connected to a medical facility network, the method comprising:

receiving data in a format native to the medical device that is different from the format of the medical facility network;

decoding the data to another data format; and

transmitting the data over the medical facility network.

In an exemplary embodiment, further comprising determining a change in the data received.

In an exemplary embodiment, wherein the change is determined by processing the data as received.

In an exemplary embodiment, wherein the change is determined by processing the decoded data.

In an exemplary embodiment, further comprising transmitting changes in the data.

In an exemplary embodiment, wherein the received data includes analog data.

In an exemplary embodiment, wherein the received data includes digital data.

In an exemplary embodiment, a decoding, modeling and presentation system representing information collected and analyzed from a medical device is provided.

In an exemplary embodiment, the model may group related metrics and/or values together to form another composite metrics.

In yet another exemplary embodiment, a decoding system for information received from a medical device is provided whereby the system uses a software algorithm as described herein to decode or extrapolate information received from a networked medical device.

In an exemplary embodiment, it is contemplated that the system may provide access to any number of medical devices in a health care facility. A Medical Device Gateway (MDG) forms at least part of the system for identifying, connecting and interpreting data from a medical device in a health care facility with a hospital's information system.

In an exemplary embodiment, the present invention relates to the analysis and decoding of raw data from a plurality of different types of medical devices in a hospital network.

In still another exemplary embodiment, the present invention allows for extrapolation of information from raw data and/or information received from a plurality of medical devices located within a medical network whereby the data is received by the system and data is analyzed and decoded to determine which medical device from which of the data it originated and the type of data it represents.

Still another exemplary embodiment provides a system and method for analysis and decoding of information received from a medical device by utilizing sensors which produce a metric representing values for each of the medical devices.

In an exemplary embodiment, a system and method for analysis, decoding, modeling and presentation of information received from a medical device is provided whereby the system provides an end user with information based on a decoding mechanism that decodes information received from the medical device and presents it to the end user in a manner desired by that user.

Still another exemplary embodiment provides a system and method for the analysis, decoding, modeling and presentation of information received from a medical device whereby the system may decode information and/or data received from any of a plurality of medical devices whereby the system may utilize a decoding mechanism whereby the decoding mechanism recognizes information from each different medical device and may determine metrics and/or values from the information received from the device.

In yet another exemplary embodiment, a system and method to analyze, decode, model and present information to an end user from a plurality of medical devices is provided whereby the system has a sensor that produces a metric that decodes information from the medical devices and sends it to the modeling portion of the system for further evaluation and manipulation.

Yet another exemplary embodiment provides a system and method to analyze, decode, model and present information to an end user from a plurality of medical devices whereby the system may also include a presentation portion whereby the presentation portion allows the end user to view the data received and decoded from the medical device in a manner best understood by the end user whereby the end user may be an individual and/or another hardware device.

Still another exemplary embodiment provides a system and method to analyze, decode, model and present information to an end user from a plurality of medical devices whereby the system may have a conduit manager to create a direct communication tunnel to a medical device.

Further, in an exemplary embodiment, a system and method may analyze, decode, model and present information to an end user from a plurality of medical devices whereby the system may have a first device server that resides in a first local network and the second device server that resides in a second local network distinct from the first local network.

It is contemplated that the system has at least a decoder mechanism, a modeling mechanism and a presentation module whereby the presentation of information from a medical device is made available to an end user for further processing of information from the medical device in a health care setting.

In still another exemplary embodiment, a system and method to analyze, decode, model and present information to an end user from a plurality of medical devices is provided. The system can include a user interface with easy to understand presentation models. This may allow the user to understand information received from any of the medical devices connected to a health care network even though the medical network (or networks) includes different medical devices having very different software and data mechanisms.

It is contemplated that the system and method may receive information from the plurality of different medical devices, and once received, determine the type of information that the data represents (such as a heart monitor, oxygen saturation monitor, etc.) by utilizing a decoding mechanism which monitors the data to determine the type of machine the data belongs to. Additionally, once the system identifies the type of medical device associated with the data, the system may then decode the information including metrics which are values that are extracted from the raw data received from the medical devices. Once that information has been decoded and metrics have been provided, the system forwards the information to a model portion which formats the information in a way that is most useful for the end user. This format may include any of: grouping, applying, structures, charting, and the like. Further, after the modeling function has been performed which formats the decoded metrics including the most useful format; the information is relayed to a presentation module which presents the information to the end user in such a way that it is easily understood, analyzed and utilizable.

Yet another exemplary embodiment of the present invention provides a system and method to analyze, decode, model and present information to an end user from a plurality of medical devices, whereby the system utilizes a plurality of controllers which look for changes in information and data that is decoded by the decoding mechanism.

Still another exemplary embodiment of the present invention provides a system and method to analyze, decode, model and present information to an end user from a plurality of medical devices whereby the system employs a controller which looks for changes in information received from the medical device to determine if errors have occurred, or upgrades have been implemented in the medical network, whereby the controller may effectuate changes to the metrics to automatically upgrade and update the system when new medical devices are introduced or changed in the health care network facility area.

### BRIEF DESCRIPTION OF THE DRAWING

The multiple drawings refer to the embodiments of the invention.

FIG. 1 is a block diagram illustrating an example decoding, modeling, and presentation system, in accordance with some embodiments.

FIG. 2 is a block diagram illustrating an example decoding, modeling, and presentation system, in accordance with some embodiments.

FIG. 3 is a flow diagram illustrating an example process in accordance with some embodiments.

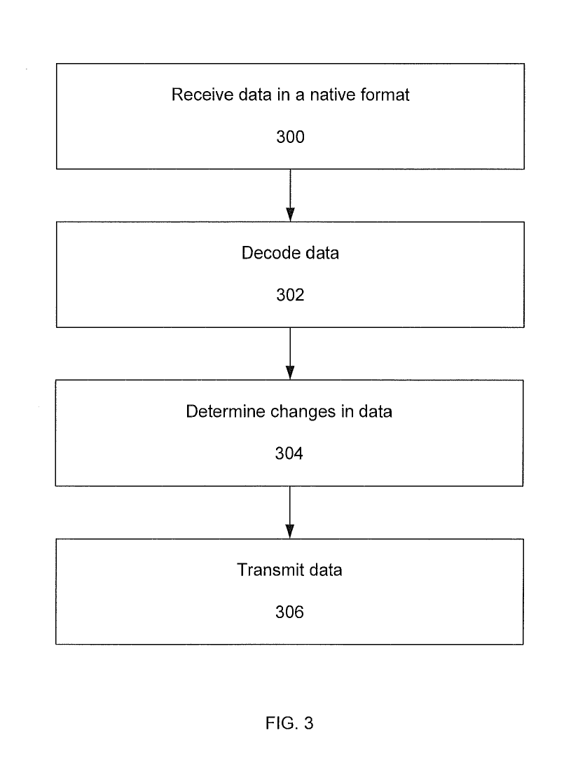

Various objects, features, aspects and advantages of the present invention will become more apparent from the following detailed description of preferred embodiments of the invention. While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DESCRIPTION

In the following description, numerous specific details are set forth, such as examples of specific voltages, named components, connections, types of circuits, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Further specific numeric references such as a first device server, a second device server, etc. may be made. However, the specific numeric reference should not be interpreted as a literal sequential order but rather interpreted that the first device server is different than the second device server. Thus, the specific details set forth are merely exemplary. The specific details may be varied from and still be contemplated to be within the spirit and scope of the present invention.

In an embodiment, a system may allow for communication, decoding, interpretation and presentation of information received from a plurality of medical devices in a health care network. Information that is received from the medical device may be decoded by the system into metrics based on values extracted from the medical device. The system may then model the decoded information and/or metrics into a format which is most useful for an end user.

Additionally, the system may then have a presentation model which allows the information to be presented to the end user via a preferred display mechanism. In an embodiment, the mechanism may be a chart, graph or text readout. Moreover, the system may further have a sensor incorporated therein which produces the metric and decodes the raw data received from the medical devices. Further, the system may also include at least a controller which may view all data received from medical devices and analyze for changes in medical software to determine if errors or upgrades to the medical devices have been implemented. In addition, the model is bidirectional in that it may be used to represent data and can be modified by applications and the changes may be reflected by the medical device.

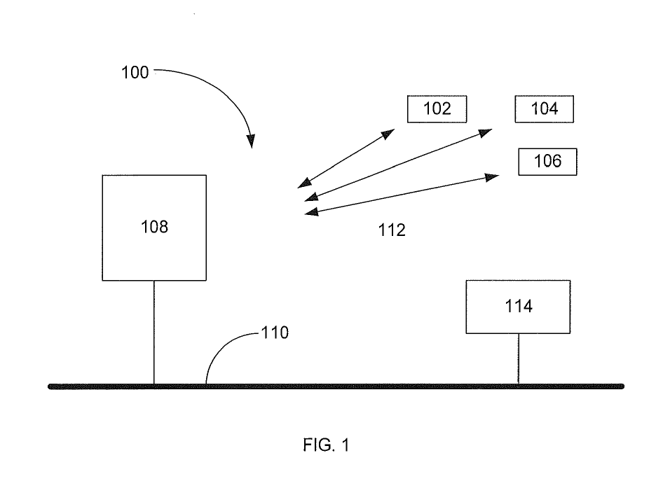

FIG. 1 is a block diagram illustrating an example decoding, modeling and presentation system 100. The system 100 can be used to receive information from a plurality of medical devices 102, 104, 106. The medical devices 102, 104, 106 may each operate independently from each other, may have different interfaces, and may produce different types of signals from each other.

In the illustrated embodiment a terminal 108 may be used to receive information signals 112 from the medical devices 102, 104, 106. The terminal 108 can be connected to a medical facility network 110. In this way data from the terminal 108 may be accessed by other computing devices connected to the network 110. In an embodiment the terminal 108 may automatically push information out to the network 110.

The terminal 108 can receive information signals 112 from the medical devices 102, 104, 106. This information signals 112 may be provided in a number of different formats that may be native to a specific medical device 102, 104, 106. For example, medical device 102 may use a proprietary format from a first vendor that is not compatible with formats used by devices 104 and 106. Medical device 104 might provide an analog signal that represents a patient's vital signs and that is not saved, which medical device 106 might store digital data representing the patient's medical readings.

Accordingly, terminal 108 may include an interface that can communicate with each medical device 102, 104, 106. For example, the terminal 108 may include a first interface to a first medical device 102. The terminal may also include a second interface to a second medical device 104 while a third interface in terminal 108 can be used to provide connectivity to a third medical device 106.

The system can further include a presentation module 114. The presentation module 114 can present information to an end user in a way that the data may be understood by the user. In some embodiments the presentation module 114 may be connected to the network 110 to allow data to be communicated between terminal 108 and the presentation module 114.

The systems and methods described herein may analyze and decode raw data from a plurality of different types of medical devices 102, 104, 106 in a hospital network 110. Some embodiments provide for extrapolation of information from raw data and/or information received from a plurality of medical devices 102, 104, 106 located within a medical network 110 whereby the data is received by the system and data is analyzed and decoded to determine which medical device the data originated from and the type of data it represents. These systems and methods may analyze and decode information received from a medical device 102, 104, 106 by utilizing sensors which produce a metric representing values for each of the medical devices.

The example system 100 may provide an end user with information based on a decoding mechanism that decodes information received from the medical device 102, 104, 106 and presents it to the end user in a manner desired by that user. The example system 100 may decode information and/or data received from any of the plurality of medical devices 102, 104, 106 whereby the system 100 may utilize a decoding mechanism whereby the decoding mechanism recognizes information from each different medical device and may determine metrics and/or values from the information received from the device. The plurality of medical devices may also be provided whereby the system 100 may have a sensor that produces a metric that decodes information from the medical devices 102, 104, 106 and sends it to the modeling portion of the system for further evaluation and manipulation.

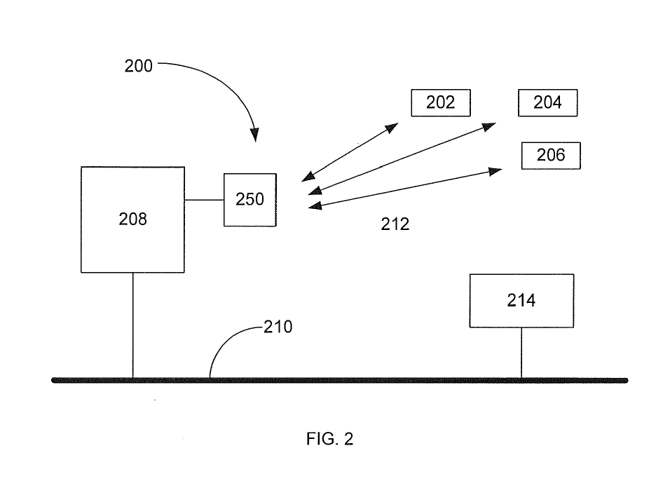

FIG. 2 is a block diagram illustrating an example decoding, modeling and presentation system 200. The system 200 can be used to receive information from a plurality of medical devices 202, 204, 206. The medical devices 202, 204, 206 may each operate independently from each other, may have different interfaces, and may produce different types of signals from each other. In this way multiple medical devices 202, 204, 206 having different interfaces may be attached to the network 210.

In the illustrated embodiment a terminal 208 may be used to receive information signals 212 from the medical devices 202, 204, 206. The terminal 208 can be connected to a medical facility network 210. In this way data from the terminal 208 may be accessed by other computing devices connected to the network 210. In an embodiment the terminal 208 may automatically push information out to the network 210.

The terminal 208 can receive information signals 212 from the medical devices 202, 204, 206. These information signals 212 may be provided in a number of different formats that may be native to a specific medical device 202, 204, 206. For example, medical device 202 may use a proprietary format from a first vendor that is not compatible with formats used by devices 204 and 206. Medical device 204 might provide an analog signal that represents a patient's vital signs that is not saved, whereas medical device 206 might store digital data representing the patient's medical readings, for example.

Accordingly, receiver-decoder 250 may include an interface that can communicate with each medical device 202, 204, 206. For example, the receiver-decoder 250 may include a first interface to a first medical device 202. The terminal 208 may also include a second interface to a second medical device 204 while a third interface in the receiver-decoder 250 can be used to provide connectivity to a third medical device 206. A terminal 208 can be connected to the receiver-decoder 250. In the illustrated embodiment of FIG. 2 the terminal 208 is connected to a network 210.

Similar to the discussion above with respect to FIG. 1, the system of FIG. 2 can further include a presentation module 214. The presentation module 214 can present information to an end user in a way that the data may be understood by the user. In some embodiments the presentation module 214 may be connected to the network 210 to allow data to be communicated between terminal 208 and the presentation module 214.

It will be understood that the decoded data may be processed in various ways. For example, as discussed above, it may be digitalized and packetized. In some embodiments the data may be further processed before the data is transmitted. For example, if the device that performs the decoding includes enough processing capability it might transform the data, e.g., into charts, graphs, etc. Accordingly, it will be understood that the systems and methods described herein may be partitioned in various ways such that steps are performed in different systems in different embodiments.

The systems and methods described with respect to FIGS. 1 and 2 may provide for a system for decoding and presenting information from a medical device connected to a medical facility network. As discussed, some embodiments include a terminal 108, 208 interfacing with the medical facility network 110, 210. In some cases, a plurality of medical devices 102, 104, 106, 202, 204, 206 may be within range of the medical facility network. The information received from the plurality of medical devices 102, 104, 106, 202, 204, 206 can be transmitted to a system processor which reads the information received and decodes the information into utilizable metrics which are then transmitted to a modeling module for further processing. Such a processor might be part of the terminal 108, 208, part of the receiver-decoder 250, a processor in, e.g., a computer connected over networks 110, 210, or other configurations.

In an embodiment the plurality of medical devices 102, 104, 106, 202, 204, 206 may be identified and information from the plurality of medical devices 102, 104, 106, 202, 204, 206 may be decoded. Additionally, the system may provide a modeling module whereby the modeling module presents information from the plurality of medical devices to an end user in a pre-determined fashion. The modeling module might be part of the terminal 108, 208, part of the receiver-decoder 250, a processor in, e.g., a computer connected over network 110, 210, or other configurations. The modeling module may transform decoded information from a medical device into any of a chart, group, or structure that is readily useable by an end user.

Some embodiments of the systems described herein may include a presentation module which presents the information to the end user in a way that data is fully understood by the end user. The presentation module might be part of the terminal 108, 208, part of the receiver-decoder 250, a processor in, e.g., a computer connected over network 110, 210, or other configurations.

Some embodiments may include a controller which looks for changes in information received from the plurality of medical devices. The system may also include a controller which reviews for changes in software, hardware and automatically upgrades the system when a change has been detected. A controller can also track data related to the most current software versions and hardware versions and determines when a medical device connected to the system requires an upgrade. These may be separate controllers, a single controller or the functionality of the controllers may be part of other system components.

Some embodiments may include a sensor that produces a metric that decodes information from the medical devices and sends it to the modeling portion of the system for further evaluation and manipulation. For example, a system and method for analysis and decoding of information received from a medical device may utilize sensors which produce a metric representing values for each of the medical devices.

In an exemplary embodiment, it is contemplated that the system may provide access to any number of medical devices in a health care facility. A Medical Device Gateway (MDG) can form at least part of the system for identifying, connecting and interpreting data from a medical device in a health care facility within a hospital's information system. For example, the MDG may provide connectivity between the medical devices and the hospital's medical network or medical information systems.

In some embodiments, the method for decoding and presenting information from a medical device connected to a medical facility network may include (1) receiving data in a format native to the medical device that is different from the format of the medical facility network 300; (2) decoding the data to another data format 302; and (3) transmitting the data over the medical facility network 306. In other embodiments the method can further comprise of determining a change in the data received 304. In an embodiment, a change might be determined by processing the data as received. Alternatively, a change might be determined by processing the decoded data.

In an exemplary embodiment, a decoding, modeling and presentation system representing information collected and analyzed from a medical device is provided. The model may group related metrics and/or values together to form another composite metric. Further, a decoding system for information received from a medical device is provided whereby the system uses a software algorithm to decode or extrapolate information received from a networked medical device.

Additionally, in some embodiments, the amount of data transmitted might be decreased by only transmitting changes in the data. (It may be necessary to transmit one or complete data sets from time to time for the entire network, or for components within the network, e.g., when the system is initially powered up, at a predetermined interval, when new devices are added to be monitored, etc.) Some embodiments may receive data that includes analog data, digital data, or both. The system may be customized to process the particular types of data and the number of devices in the hospital, for example. The method may further include presenting information from the plurality of medical devices to an end user in a pre-determined fashion, transforming decoded data from a medical device into any of, for example, a chart, group, or structure that is readily useable by an end user.

Example systems and methods described herein have been used in conjunction with a medical facility network. Such a network can include a local network or facility wide network. It will be understood, however, that the systems and methods described herein may be applied to other networked devices and systems. Further, the skilled artisan will recognize the interchangeability of various features from different embodiments. Similarly, the various features and steps discussed above, as well as other known equivalents for each such feature or step, can be mixed and matched by one of ordinary skill in this art to perform compositions or methods in accordance with the principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein. For example, while various embodiments have been described with respect to a medical network, it will be understood that the systems and methods might be applied to other electronic devices and networked systems.

What is claimed is:

1. A system for decoding and presenting information from a medical device connected to a medical facility network, the system comprising:
a terminal interfacing with the medical facility network and comprising a controller configured to determine if medical device data comprises changes;
a plurality of medical devices within range of the medical facility network; and
wherein the terminal device receives information from the plurality of medical devices; the controller upon detection of an unexpected change in the information, automatically effectuates an update to utilizable metrics; the information is transmitted to a system processor which reads the information received and decodes the information into utilizable metrics based on the update and which are then transmitted to a modeling module for further processing.

2. The system of claim 1 wherein a plurality of medical devices may be identified and information from a plurality of medical devices may be decoded.

3. The system of claim 1, wherein the system provides a modeling module whereby the modeling module which presents information from the plurality of medical devices to an end user in a pre-determined fashion.

4. The system of claim 1, wherein the system provides a modeling module which transforms decoded information from a medical device into any of a chart, group, or structure that is readily useable by an end user.

5. The system of claim 1, wherein the system further comprises a presentation module which presents the information to the end user in a way that the data is fully understood by the end user.

6. The system of claim 1, wherein the system further comprises the controller which looks for errors in information received from the plurality of medical devices.

7. The system of claim 1, wherein the system further comprises the controller which reviews for changes in software, hardware and automatically upgrades the system when a change has been detected.

8. The system of claim 7, wherein the controller tracks data related to the most current software versions and hardware versions and determines when a medical device connected to the system requires an upgrade.

9. The system of claim 1, further comprising of a sensor that produces a metric that decodes information from the medical devices and sends it to the modeling portion of the system for further evaluation and manipulation.

10. The system of claim 1, further comprising a Medical Device Gateway (MDG).

11. A method for decoding and presenting information from a medical device connected to a medical facility network, the method comprising:
receiving, by a terminal device, data in a format native to the medical device that is different from the format of the medical facility network;
detecting, by a controller, an unexpected change in the data and automatically effectuating an update to utilizable metrics;
decoding the data into the utilizable metrics based on the update and to another data format; and
transmitting the data, including the updated utilizable metrics, over the medical facility network.

12. The method of claim 11, further comprising determining a change in the data received.

13. The method of claim 12, wherein the change is determined by processing the data as received.

14. The method of claim 12, wherein the change is determined by processing the decoded data.

15. The method of claim 12, further comprising transmitting changes in the data.

16. The method of claim 11, wherein the received data includes analog data.

17. The method of claim 11, wherein the received data includes digital data.

18. The method of claim 11, further comprising presenting information from the plurality of medical devices to an end user in a pre-determined fashion.

19. The method of claim 11, further comprising transforming decoded data from a medical device into any of a chart, group, or structure that is readily useable by an end user.

20. The method of claim 11, reviewing for changes in software, hardware and automatically upgrading the system when a change has been detected.
